(19) United States
(12) Patent Application Publication
(10) Pub. No.: US 2016/0078551 A1
(43) Pub. Date: Mar. 17, 2016

(54) Method and System for Generating and Distributing Optimized Life Insurance Packages and Visual Representations Thereof

(71) Applicant: Insamco Holdings, LLC, Santa Barbara, CA (US)

(72) Inventor: Jonathan H. Samuels, Santa Barbara, CA (US)

(21) Appl. No.: 14/852,994

(22) Filed: Sep. 14, 2015

Related U.S. Application Data
(60) Provisional application No. 62/049,627, filed on Sep. 12, 2014.

(51) Int. Cl. G06Q 40/08

(52) U.S. Cl. CPC G06Q 40/08

(57) ABSTRACT

A method for generating an optimized life insurance package includes the steps of collecting consumer data comprising an age and a risk class, determining a match between at least one life insurance policy and at least one Life Insurance Option, wherein the match is determined based at least partially on a period of coverage for the at least one life insurance policy and at least a portion of the consumer data, generating an optimized life insurance package comprising the at least one Life Insurance Option, and transmitting data configured to generate at least one graphical user interface comprising a visual representation of the optimized life insurance package. Other methods, systems, and computer program products are also disclosed.

### CROSS REFERENCE TO RELATED APPLICATION

This application claims benefit of priority from U.S. Provisional Patent Application No. 62/049,627, filed Sep. 12, 2014, which is incorporated by reference in its entirety.

### BACKGROUND OF THE INVENTION

1. Field of the Invention

The present disclosure relates to generating optimized life insurance packages and illustrations thereof, specifically the optimization of a life insurance package of at least one life insurance policy and at least one Life Insurance Option based at least partially on consumer data.

2. Description of Related Art

Life insurance is commonly offered to consumers as a way to insure the life of an individual against the financial consequences resulting from death. Generally, a life insurance policy pays a benefit if the insured life dies during the term of the policy, provided that the terms and conditions of the policy have been fulfilled. For example, most life insurance policies require the continued payment of premiums in order to keep the policy active and not have the policy lapse.

Life insurance options may be similar to life insurance policies, in that they may pay a benefit if the insured life dies during the term of the option. However, Life Insurance Options are different from life insurance policies in that they are options for future insurability for the consumer at a later date. A Life Insurance Option may provide for future insurability for the consumer at a present risk class, at a predetermined premium, and/or defined by other parameters. For example, a 40 year old consumer may obtain a Life Insurance Option at a specific risk class that starts after ten years, when the consumer is 50, and has a period of coverage for twenty years. When the ten-year period has completed, the consumer may then take advantage of the option and obtain a life insurance policy at a premium stipulated in the option and for the twenty-year period of coverage. Life insurance options and methods for generating and identifying premiums and details thereof can be found in the following references: U.S. patent application Ser. No. 14/095,225, entitled “System and Method for Calculating a Premium for a Life Insurance Option,” by Jonathan Samuels et al., filed on Dec. 3, 2013, which is herein incorporated by reference in its entirety; U.S. patent application Ser. No. 11/256,320, entitled “Life Insurance Option,” by Jonathan H. Samuels, filed on Oct. 21, 2005 and issued as U.S. Pat. No. 7,797,174, which is also herein incorporated by reference in its entirety.

As Life Insurance Options and other new types of life insurance policies enter the market, some consumers may wish to combine policies. For example, a consumer may desire to combine a term life insurance policy with a Life Insurance Option for ongoing coverage at a current risk class. However, due to the overwhelming number of coverage options with life insurance policies due to differences in premiums, coverage amounts, terms, exclusions, riders, and other factors, it may be exceedingly difficult for consumers to identify any particular type of policy, let alone a package of policies, that may be ideal for the type of coverage they have in mind.

Thus, there is a need for a technical solution to the technical problem of identifying optimal life insurance packages of life insurance policies.

### SUMMARY OF THE INVENTION

Therefore, it is an object of the present invention to provide a system, method, and computer program product for generating optimized life insurance packages and illustrating Life Insurance Options that address or overcome certain drawbacks and deficiencies in existing systems and methods.

According to one preferred and non-limiting embodiment of the present invention, provided is a computer-implemented method for generating an optimized life insurance package, comprising: collecting, through at least one graphical user interface, consumer data comprising an age and a risk class; determining, with at least one processor, a match between at least one life insurance policy and at least one Life Insurance Option, wherein the match is determined based at least partially on a period of coverage for the at least one life insurance policy and at least a portion of the consumer data; generating an optimized life insurance package comprising the at least one Life Insurance Option; and transmitting, to the user computer, data configured to generate at least one graphical user interface comprising a visual representation of the optimized life insurance package.

In non-limiting embodiments, the match is determined by at least the following steps: determining, with at least one processor, associations between a plurality of life insurance policies stored in at least one life insurance database and a plurality of Life Insurance Options, wherein each life insurance policy corresponds to eligibility requirements; determining a plurality of eligible life insurance policies and the plurality of Life Insurance Options based at least partially on the consumer data and the eligibility requirements, wherein a consumer associated with the consumer data meets the eligibility requirements for the plurality of life insurance policies; and identifying, with at least one processor, the at least one life insurance policy from the plurality of life insurance policies and the at least one Life Insurance Option from the plurality of Life Insurance Options based at least partially on the associations.

In some non-limiting embodiments, the optimized life insurance package comprises the at least one life insurance policy, and the at least one life insurance policy is identified: based on the consumer data, based on input from the consumer, based on input from an agent, based on input from an advisor, based on input from a representative, or any combination thereof. Further, the at least one life insurance database may include, for example, at least one of a local database and a remote third-party database. In some examples, the visual representation may include at least one policy illustration of the optimized life insurance package.

In non-limiting embodiments, the optimized life insurance package may comprise a plurality of Life Insurance Options, and the at least one policy illustration may comprise a premium and option period for each of the plurality of Life Insurance Options. Additionally, the at least one policy illustration may comprise an interactive user interface programmed to facilitate a user to interact with the at least one policy illustration. In some examples, the at least one Life Insurance Option may comprise a guarantee that the consumer can exercise an option, at a later time, to do at least one of the following: purchase at least one life insurance policy at a guaranteed price, purchase at least one life insurance policy at a guaranteed risk class, or any combination thereof.

The method may also include, in some non-limiting embodiments, the step of receiving a selection of a Life Insurance Option from the at least one Life Insurance Option, wherein the Life Insurance Option comprises an option contract that guarantees the consumer an ability to purchase a life insurance policy corresponding to the Life Insurance Option at or after a specified period of time or date. Further, the optimized life insurance package may include a life insurance policy having a term, and wherein the at least one Life Insurance Option is based on the term of the life insurance policy. The optimized life insurance package may comprise a plurality of life insurance policies each having terms, and the aggregate terms of the plurality of life insurance policies may extend over a coverage period. In non-limiting examples, the at least one Life Insurance Option may comprise an option date, wherein the optimized life insurance package comprises at least one life insurance policy having a term, and wherein the at least one Life Insurance Option is determined based at least partially on the option date and the term of the at least one life insurance policy.

In non-limiting embodiments, the period of coverage for the at least one life insurance policy may be flexible. Further, the consumer data may further comprise at least one of the following: coverage objectives, financial objectives, risk tolerance, desired coverage, anticipated timing, or any combination thereof. In some examples, determining the match between the at least one life insurance policy and the at least one Life Insurance Option comprises identifying a pre-defined package comprising the at least one life insurance policy and the at least one Life Insurance Option.

According to another preferred and non-limiting embodiment of the present invention, provided is a computer program product for generating an optimized life insurance package, comprising at least one non-transitory medium containing program instructions that, when executed by at least one processor of at least one computer, cause the at least one computer to: transmit, to a user computer, data configured to generate at least one graphical user interface programmed to collect consumer data, the consumer data comprising an age and a risk class; determine at least one Life Insurance Option available to the consumer based at least partially on the consumer data and a term of at least one life insurance policy, the at least one Life Insurance Option comprising an option date and a cost; and generate at least one life insurance policy illustration based at least partially on the at least one Life Insurance Option.

In some non-limiting embodiments, the at least one life insurance policy is identified based at least partially on the consumer data, and the at least one life insurance policy illustration is generated based at least partially on the at least one life insurance policy. Further, in some examples, the at least one life insurance policy may be owned by the consumer, and the at least one graphical user interface may be further programmed to collect policy information regarding the at least one life insurance policy.

In non-limiting embodiments, determining the at least one Life Insurance Option available to the consumer comprises: determining a match between at least one life insurance policy and the at least one Life Insurance Option, wherein the match is determined based at least partially on a period of coverage for the at least one life insurance policy and at least a portion of the consumer data. Determining the match between the at least one life insurance policy and the at least one Life Insurance Option may include the steps of: determining, with at least one processor, associations between a plurality of life insurance policies and a plurality of Life Insurance Options, wherein each life insurance policy corresponds to eligibility requirements; determining a plurality of eligible life insurance policies and a plurality of Life Insurance Options based at least partially on the consumer data and the eligibility requirements, wherein a consumer associated with the consumer data meets the eligibility requirements for the plurality of life insurance policies; and identifying, with at least one processor, the at least one life insurance policy from the plurality of life insurance policies and the at least one Life Insurance Option from the plurality of Life Insurance Options based at least partially on the associations.

In non-limiting embodiments, the visual representation may comprise at least one policy illustration of the optimized life insurance package, and the at least one policy illustration may comprise a premium and option period for each of the plurality of Life Insurance Options. Additionally, the at least one policy illustration may comprise an interactive user interface programmed to facilitate a user to select at least one Life Insurance Option. In some embodiments, the program instructions, when executed by the at least one processor of the at least one computer, further cause the at least one computer to: receive a selection of a Life Insurance Option from the at least one Life Insurance Option, wherein the Life Insurance Option comprises an option contract that allows the consumer to exercise an option, at a later time, to do at least one of the following: purchase at least one life insurance policy at a guaranteed price, purchase at least one life insurance policy at a guaranteed risk class, or any combination thereof.

In some non-limiting embodiments, the optimized life insurance package may include a life insurance policy having a term, and the at least one Life Insurance Option may be based on the term of the life insurance policy. Further, determining the at least one Life Insurance Option available to the consumer may comprise the step of: generating an optimal life insurance package for the consumer, the optimal life insurance package including the at least one Life Insurance Option and the at least one life insurance policy, wherein the at least one Life Insurance Option corresponds to the at least one life insurance policy based at least partially on a period of coverage for the at least one life insurance policy.

According to a further preferred and non-limiting embodiment of the present invention, provided is a system for generating an optimized life insurance package, comprising at least one server computer including at least one processor, the at least one server computer programmed to: generate at least one graphical user interface; collect, through the at least one graphical user interface, consumer data comprising an age and a risk class; identify at least one Life Insurance Option that matches at least one life insurance policy based at least partially on a coverage period for the at least one life insurance policy and at least a portion of the consumer data; generate an optimized life insurance package comprising the at least one Life Insurance Option; and generate at least one policy illustration of the optimized life insurance package.

In non-limiting embodiments, the at least one life insurance policy is input by a user. Further, the at least one Life Insurance Option may be determined in non-limiting embodiments by: determining, with at least one processor, associations between a plurality of life insurance policies and a plurality of Life Insurance Options, wherein each life insurance policy corresponds to eligibility requirements; determining a plurality of eligible life insurance policies and a plurality of corresponding Life Insurance Options based at least partially on the consumer data and the eligibility requirements, wherein a consumer associated with the consumer data meets the eligibility requirements for the plurality of life insurance policies; and identifying, with at least one processor, the at least one Life Insurance Option from the plurality of Life Insurance Options based at least partially on the associations.

In further non-limiting embodiments, the at least one policy illustration may comprise a premium and option period for each of the plurality of Life Insurance Options. The at least one Life Insurance Option may comprise a guarantee that the consumer can exercise an option, at a later time, to do at least one of the following: purchase at least one life insurance policy at a guaranteed price, purchase at least one life insurance policy at a guaranteed risk class, or any combination thereof. Additionally, the at least one server computer may be further programmed to: receive a selection of a Life Insurance Option from the at least one Life Insurance Option, wherein the Life Insurance Option comprises an option contract that guarantees the consumer an ability to purchase a life insurance policy corresponding to the Life Insurance Option at or after a specified period of time or date.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

The scope of the present disclosure is best understood from the following detailed description of exemplary embodiments when read in conjunction with the accompanying drawings. Included in the drawings are the following figures:

FIG. 1 is a schematic view of a system for generating Life Insurance Options and visual representations thereof in accordance with the principles of the present invention.

FIG. 2 is a schematic view of the processing server of FIG. 1 for the generation of Life Insurance Options and visual representations thereof in accordance with the principles of the present invention.

FIG. 3 is a flow diagram of a process for generating an optimized life insurance package using the system of FIG. 1 in accordance with the principles of the present invention.

FIG. 4 is a flow diagram of a process for providing visual representations of Life Insurance Options and life insurance policies using the system of FIG. 1 in accordance with the principles of the present invention.

FIG. 5 is a flow diagram of a process for generating an optimized life insurance package using the processing server of FIG. 2 in accordance with the principles of the present invention.

FIG. 6 is a flow diagram of a process for generating visual representations of Life Insurance Options and life insurance policies using the processing server of FIG. 2 in accordance with the principles of the present invention.

FIGS. 7A and 7B are diagrams illustrating example illustrations of Life Insurance Options and policies generated using the processing server of FIG. 2 in accordance with the principles of the present invention.

FIG. 8 is a flow chart of a method for generating an optimized life insurance package in accordance with the principles of the present invention.

FIG. 9 is a flow chart of a method for generating visual representations of Life Insurance Options for purchase by a consumer in accordance with the principles of the present invention.

FIG. 10 is a comparison interface according to the principles of the present invention.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

For purposes of the description hereinafter, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

As used herein, the terms “communication” and “communicate” refer to the receipt or transfer of one or more signals, messages, commands, or other type of data. For one unit or component to be in communication with another unit or component means that the one unit or component is able to directly or indirectly receive data from and/or transmit data to the other unit or component. This can refer to a direct or indirect connection that may be wired and/or wireless in nature. Additionally, two units or components may be in communication with each other even though the data transmitted may be modified, processed, and/or routed between the first and second unit or component. For example, a first unit may be in communication with a second unit even though the first unit passively receives data, and does not actively transmit data to the second unit. As another example, a first unit may be in communication with a second unit if an intermediary unit processes data from one unit and transmits processed data to the second unit. It will be appreciated that numerous other arrangements are possible.

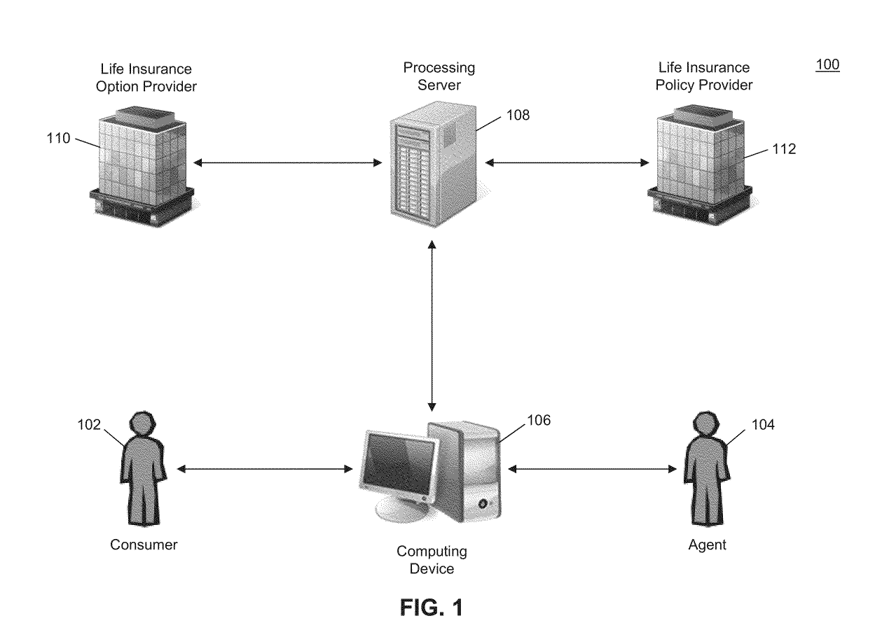

FIG. 1 illustrates a system 100 according to a preferred and non-limiting embodiment of the present invention for the generation of optimized life insurance packages and visual representations of Life Insurance Options and packages for presentation to a consumer for purchase.

Referring to FIG. 1, the system 100 may include a consumer 102 and/or a graphical user interface (GUI) that is accessible by the consumer 102 or an agent, representative, or advisor of the consumer 102. The consumer 102 may have a desire to purchase a Life Insurance Option or package. A Life Insurance Option may be a guarantee of future insurability for the consumer 102 such that, at a later date as specified by the Life Insurance Option, the consumer 102 may be able to purchase a life insurance policy based on the option, which is identified using the consumer's current risk class or using a pre-defined premium cost. The Life Insurance Option may be a separate product from an initial life insurance policy, rather than a rider thereto, to provide greater options and choices to the consumer 102. However, it will be appreciated that the Life Insurance Option may also be a rider to one or more standard life insurance policies. To identify different Life Insurance Options that may be available to the consumer 102, the consumer 102 may visit an agent (e.g., an insurance agent, advisor, and/or representative), such as the agent 104, either in person or through one or more computing devices 106. The agent 104 may be a person or an automated, specially programmed interactive computer system accessible through a communications network such as the Internet or a local area network (LAN), a kiosk, and/or any other form of computing architecture that acts as an interface to the computing device 106.

As used herein, the term Life Insurance Option refers to options for future insurance and/or insurability for a consumer at a later date. In particular, a Life Insurance Option is a policy and/or option which grants the holder the right (but not necessarily the obligation) to future life insurance coverage, thereby assuring insurability for the insured. A Life Insurance Option may provide for future insurability for a consumer at a present and/or predetermined risk class, at a predetermined premium and/or other pricing structure, and/or as defined by other parameters that may include, but are not limited to, benefit amount or range, policy type, premium payments, and the like. For example, a Life Insurance Option may guarantee a future life insurance policy at a particular premium or may guarantee a future life insurance policy at a particular risk class (e.g., based on a premium for that risk class at the time the life insurance policy starts). Numerous other variations are possible. The future life insurance coverage may be, for example, any type of life insurance policy including, but not limited to, a term policy, a universal life policy, a whole life policy, a variable policy, a survivor policy (e.g., covering more than one individual), and/or the like. A Life Insurance Option may be issued and/or structured as a life insurance policy and/or as an option contract depending on implementation, regulatory requirements, and/or other like considerations. A Life Insurance Option could be an independent product or, as explained further herein, structured as a rider to a life insurance policy. Systems and methods for providing Life Insurance Options are described in U.S. patent application Ser. No. 11/256,320, entitled “Life Insurance Option,” by Jonathan H. Samuels, filed on Oct. 21, 2005 and issued as U.S. Pat. No. 7,797,174, which is herein incorporated by reference in its entirety. Further, a Life Insurance Option may be associated with a cost (e.g., a price of purchasing an option contract) and a premium (e.g., a price of maintaining the policy once the option is exercised). It will be appreciated that Life Insurance Options may be structured in various ways and that the premiums may be calculated in various ways. Further, various payment schedules may be used.

In non-limiting embodiments, and with continued reference to FIG. 1, the agent 104 may collect consumer data from the consumer 102, such as the consumer's age, and identify a risk class from a plurality of risk classes for the consumer 102 based on their consumer data. Additional consumer data that may be collected and used in identification of the consumer's risk class will be apparent to persons having skill in the relevant art and may include, for example, exercise habits, eating habits, tobacco usage, drug usage, alcohol usage, family medical history, personal medical history, coverage objectives, financial objectives, risk tolerance, desired coverage, anticipated timing for the coverage need, and/or other parameters, characteristics, preferences, and/or values. The agent 104 may identify the risk class for the consumer 102 or, in some embodiments, may input the consumer data into a computing device 106. The computing device 106 may be configured to identify consumer risk classes based on input consumer data, such as via a specially configured software application executed by the computing device 106. It will be appreciated that, in some embodiments, the computing device 106 may be in communication with one or more remote computing devices that execute an application program (e.g., software as a service and/or the like) to identify consumer risk classes. Various other arrangements are possible. The computing device 106 may be any type of computing device suitable for performing the functions disclosed herein, such as a desktop computer, laptop computer, tablet computer, smart phone, and/or the like.

The agent 104 may also collect information regarding desired Life Insurance Options and/or packages by the consumer 102. Such information may include desired coverage amounts, coverage types, coverage lengths, premium amounts, cash flow, and other suitable information as will be apparent to persons having skill in the relevant art. The agent 104 may enter in the desired information into the computing device 106. It will be appreciated that the consumer 102 and/or other individuals may provide some or all of the consumer data directly into one or more GUIs presented by the computing device 106, and that the involvement of an agent 104 is not necessary.

With continued reference to FIG. 1, once the risk class for the consumer 102 has been identified and any consumer-desired information input, the agent 104 or other individual may submit a request for optimized life insurance packages via the computing device 106 to a processing server 108. The processing server 108, discussed in more detail below, may be configured to identify Life Insurance Options and/or optimized life insurance packages available for purchase by the consumer 102. In some examples, the processing server 108 may be programmed and/or configured to calculate and generate Life Insurance Options. In other examples, the processing server 108 may provide the consumer data to one or more Life Insurance Option providers 110. The Life Insurance Option providers 110 may then calculate the Life Insurance Options for the consumer 102 and provide the option data to the processing server 108. Other arrangements are possible.

In non-limiting embodiments, the processing server 108 may also identify life insurance policies for purchase by the consumer 102. In such embodiments, the processing server 108 may calculate life insurance policies for purchase by the consumer 102 or may request life insurance policy data from one or more life insurance policy providers 112 based on the consumer data. The type of life insurance policies identified and provided by the life insurance policy providers 112 may include any suitable type of life insurance policy, such as Life Insurance Option term life insurance policies, flexible life insurance policies, whole life insurance policies, life insurance policies with or without riders, etc. A term life insurance policy may have a definite time frame, and a whole life insurance policy may have a term which expires upon death. Such terms, for both term policies and whole life policies, typically continue as long as a premium payment is made. Further, the life insurance policy providers 112 may also identify and provide one or more Life Insurance Options.

In non-limiting embodiments, the processing server 108 may be programmed and/or configured to identify packages including at least one Life Insurance Option and at least one standard life insurance policy. Packages may be identified based on correspondence between information included or associated with each included life insurance policy and/or Life Insurance Option, such as correspondence between start and/or end dates, coverage lengths, premium amounts, coverage amounts, etc. For example, if a life insurance package includes a Life Insurance Option and a life insurance policy, the processing server 108 may match Life Insurance Options to life insurance policies based on the start date of the options and the period of coverage for the life insurance policies. For instance, the processing server 108 may match all Life Insurance Options for policies available after ten years with life insurance policies that have a period of coverage of ten years.

The processing server 108 may then identify an optimal life insurance package for the consumer 102. The optimal life insurance package may be identified based on the desired options as provided by the consumer 102, the consumer data, and the corresponding characteristics of each life insurance package. For example, if the consumer 102 or other individual requests a specific coverage type, length of coverage, and coverage amount, the processing server 108 may identify a life insurance package that best provides for the consumer's requested type, length, and amount of coverage.

As an example, the consumer 102 may request twenty years of coverage at a minimum premium amount that provides for $500,000 worth of coverage. In such an example, the processing server 108 may identify a package of a term life insurance policy that lasts ten years that provides for $500,000 with a lower premium than other comparable policies, and a Life Insurance Option that has a start date ten years into the future with a ten year term that also provides for $500,000. The processing server 108 may identify various combinations of similar term life insurance policies and Life Insurance Options that provide for the lowest premiums for the consumer 102, and identify such a package as the optimal life insurance package for the consumer 102. In some instances, multiple packages may be identified for the consumer 102 to review.

As another example, a consumer 102 may have an employer-provided life insurance policy with $250,000 coverage, with the knowledge that the policy will end upon retirement in ten years. The consumer 102 may thus request an additional $250,000 in coverage at the present time, with another $250,000 to be added on in ten years once the employer-provided policy ends. The processing server 108 may therefore identify an optimal package for the consumer 102 that provides such coverage, while also identifying included policies that may be more preferable to the consumer 102 based on other considerations, such as included exclusion or policy riders.

Once one or more optimal life insurance packages have been identified, the processing server 108 may transmit the package details to the computing device 106, which may display the package details to the agent 104, the consumer 102, and/or some other individual. The processing server 108 may also transmit information regarding other identified life insurance packages to the computing device 106, such as for comparison by the agent 104, consumer 102, and/or other individual. Once the consumer 102 has selected a package, the consumer 102 may purchase the life insurance package using methods and systems that will be apparent to persons having skill in the relevant art.

In some non-limiting embodiments, the processing server 108 may also be programmed and/or configured to generate visual representations, such as policy illustrations, for Life Insurance Options and/or generated life insurance packages. The visual representations may depict information regarding the associated Life Insurance Option, policy, and/or package, such as the start date, premium amount, and period of coverage for the corresponding policy or policies. In a preferred and non-limiting embodiment, the visual representations may be in the form of policy illustrations and may be generated pursuant to regulations regarding life insurance policy illustrations, such as model law 582 from the National Association of Insurers. The visual representations may also include charts, graphs, and/or other visual indicia that convey information regarding one or more Life Insurance Options, life insurance policies, and/or life insurance packages that are generated.

In non-limiting embodiments, the processing server 108 may generate the visual representations for each Life Insurance Option, life insurance policy, and/or life insurance package, and then transmit the visual representations to the computing device 106 for display to the agent 104, consumer 102, and/or other individual. In some embodiments, the processing server 108 may indicate the identified optimal life insurance package in the visual representation, such as by denoting in a policy illustration that the corresponding life insurance package is deemed optimal based on the criteria provided by the consumer 102.

In some instances, the processing server 108 may also identify optimal Life Insurance Options, such as in instances where the consumer 102 may be purchasing only a Life Insurance Option without additional life insurance policies as part of a life insurance package. In such an instance, the visual representation (such as a policy illustration) associated with the identified optimal Life Insurance Option may indicate the option as being the optimal one. The consumer 102 may then view the generated illustrations of Life Insurance Options and purchase a Life Insurance Option if desired using methods and systems that will be apparent to persons having skill in the relevant art.

In a non-limiting embodiment, a comparison interface is generated to allow a user (e.g., consumer, agent, advisor, representative, or other individual) to compare an optimal Life Insurance Option or Life Insurance Option package with a life insurance policy, such as a whole life policy or universal life policy. Such a comparison may be performed by displaying one or more parameters of a whole life policy or universal life policy on the same interface as one or more parameters of a Life Insurance Option or Life Insurance Option package. The comparative parameters may be arranged in adjacent columns, as an example, and include premium amounts, total cash outlays, total cash values, investable/invested cash, coverage amounts, and/or other like parameters. However, it will be appreciated that the comparative parameters may be displayed in any number of ways, and that the comparison interface may include one or more webpages, generated documents, graphics, charts, tables, graphs, and/or the like.

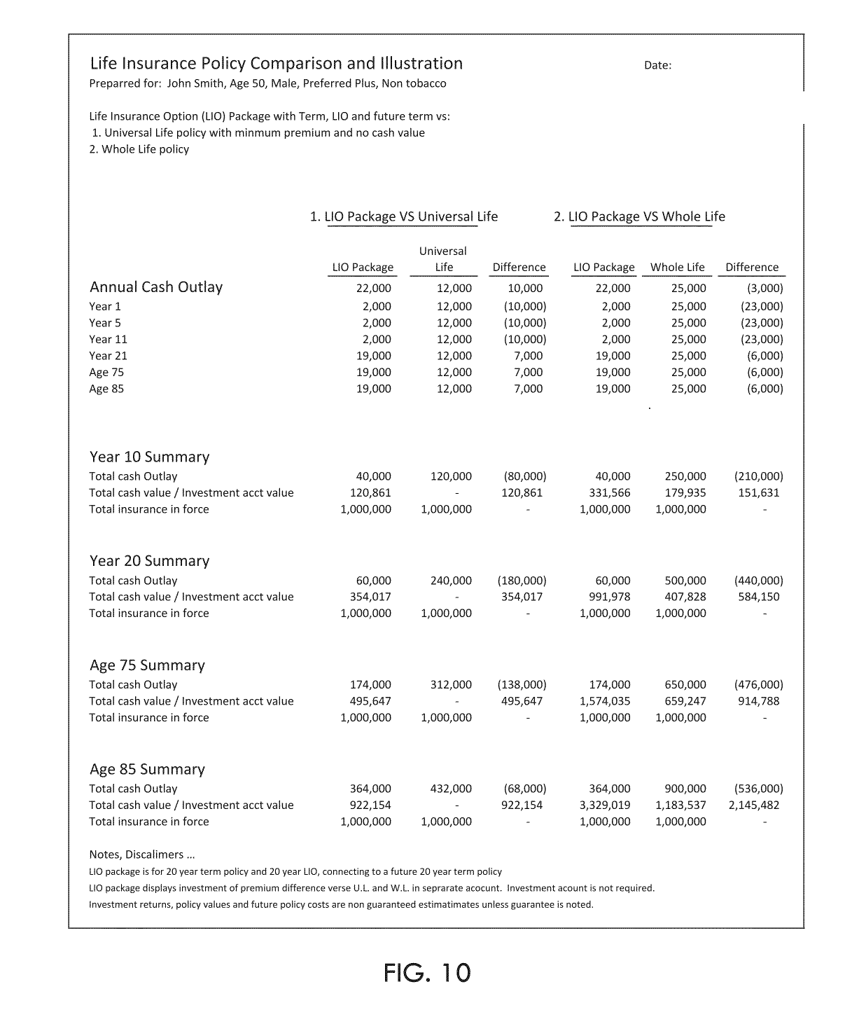

Referring now to FIG. 10, an example illustration of a comparison interface is shown according to a non-limiting embodiment. As shown, the comparison interface provides a visual comparison of parameters for an optimized Life Insurance Option package and a universal life policy over a projected lifespan of a consumer and/or length of time, and a visual comparison of parameters for an optimized Life Insurance Option package and a whole life policy over a projected lifespan of the consumer and/or length of time. An annual cash outlay is shown over a number of years and ages, including the differences between the outlays for the optimized Life Insurance Option package and the outlays for the universal life and whole life policies. Also shown in FIG. 10 are summaries for ten and twenty years, and for ages 75 and 85, including total cash outlays, total cash values and/or investment account values, and total insurance coverage in force. However, it will be appreciated that the comparison interface may be generated for any number of years and in any number of temporal increments. By viewing the comparison interface, a user is able to see the financial benefits of an optimized Life Insurance Option over a period of time, and therefore be aided in making a purchasing decision. Appendix A from U.S. Provisional Patent Application No. 62/049,627, which is hereby incorporated by reference, includes data used to generate the comparison interface shown in FIG. 10.

It will be further apparent to persons having skill in the relevant art that the configuration of the system 100 illustrated in FIG. 1 is provided as a means of illustration only and that additional configurations may be suitable for performing the functions as discussed herein. For example, in one embodiment, the computing device 106 and the processing server 108 may be a single device, or may be local and/or remote to one another. In another embodiment, the processing server 108 may be part of and/or provided by the Life Insurance Option provider 110 and/or the life insurance policy provider 112. In some instances, Life Insurance Options and life insurance policies may both be available from a single provider 110 or 112. In another embodiment, the consumer 102 may access the computing device 106 and review visual representations (such as policy illustrations) for the purchase of life insurance packages or Life Insurance Options directly, such as via a webpage or other GUI accessed over the Internet or a local area network (LAN). For clarity, only one consumer 102 and one agent 104 are shown in FIG. 1, though of course in a practical embodiment many more could be present. Further, the agent 104 may be in communication with computing devices of various insurance companies and brokerages, as would be apparent to one skilled in the art. Additional configurations will be apparent to persons having skill in the relevant art.

The use of visual representations, such as policy illustrations, to illustrate Life Insurance Options to consumers 102 for purchase may be beneficial as it may provide the consumer 102 with a simpler, more easily understood look at Life Insurance Options that may be available to them. In addition, such a system may be integrated with existing systems for providing visual representations of life insurance policies, which may further assist the consumer 102 and/or the agent 104 in reviewing and selecting Life Insurance Options, particularly in conjunction with a life insurance policy to cover the consumer 102 until the effective date of the option. In addition, visual representations of Life Insurance Options generated using the methods and systems discussed herein may be combined with visual representations of life insurance policies to provide for illustrated life insurance packages that include both a policy and option for a future policy for purchase by the consumer 102 for long-term coverage at a present risk class.

In addition to the generation of visual representations, the identification of optimal life insurance packages by the processing server 108 may greatly aid the agent 104 and/or consumer 102 in the selection and purchasing of a life insurance package. Due to the large variety of life insurance policies and Life Insurance Options that may be available, the number of different combinations of policies to create a life insurance package may be overwhelming to both consumers 102 and agents 104. The processing server 108 may be programmed and/or configured to use one or more algorithms to quickly and efficiently identify an optimal package for a consumer 102 and their desired criteria based on obtained data, which may greatly assist the consumer 102 in their selection of a life insurance package. The additional capability of providing illustrations for life insurance packages, and indicating the optimal life insurance package, may also present the data to the consumer 102 in a manner that is more easily and more conveniently digested.

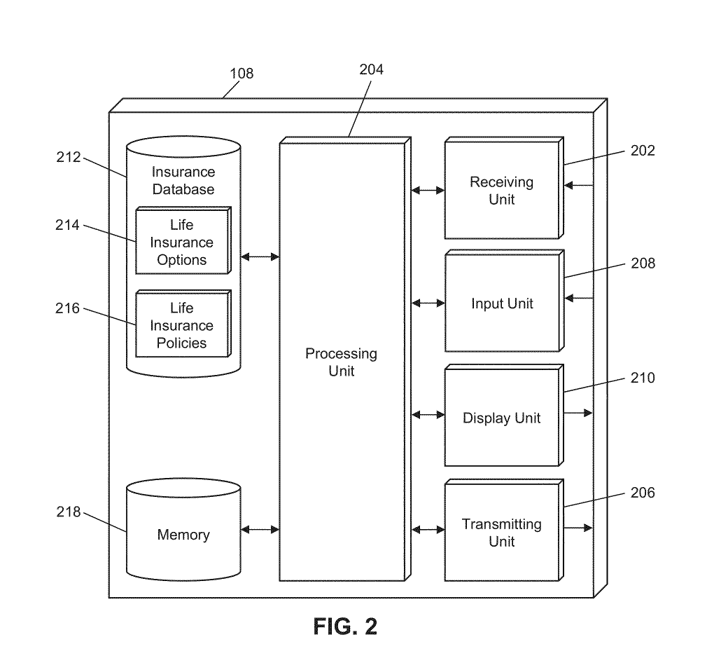

FIG. 2 illustrates an embodiment of the processing server 108 according to a preferred and non-limiting embodiment of the system 100. It will be apparent to persons having skill in the relevant art that the embodiment of the processing server 108 illustrated in FIG. 2 is provided as an example only and may not be exhaustive to all possible configurations of the processing server 108 suitable for performing the functions as discussed herein.

In non-limiting embodiments, the processing server 108 may include a receiving unit 202. The receiving unit 202 may be programmed and/or configured to receive data over one or more networks via one or more network protocols. The receiving unit 202 may receive consumer data from the computing device 106 or from other sources, which may include an age and a risk class for the consumer 102. In some instances, the receiving unit 202 may also receive additional data for use in the identification of life insurance packages and/or options for the consumer 102, such as a requested exercise date for option, a requested period of coverage, desired amount of coverage, desired type(s) of coverage, desired exclusions and/or riders, etc. The request may also identify what type(s) of policies are requested (e.g., options, packages, etc.), if visual representations are requested, and/or if the identification of an optimal policy or package is requested by the consumer 102 or the agent 104.

The processing server 108 may further include a processing unit 204, such as one or more processors, in communication with the receiving unit 202. The processing unit 204 may be programmed and/or configured to read the consumer data and information included in the request as received by the receiving unit 202. The processing server 108 may also be programmed and/or configured to execute one or more algorithms to identify Life Insurance Options based on the consumer data. In some embodiments, identifying Life Insurance Options may include generating a request for Life Insurance Options, the request including the consumer data received by the receiving unit 202. The processing server 108 may also include a transmitting unit 206 in communication with the receiving unit 202, which may be programmed and/or configured to transmit data over one or more networks via one or more network protocols, including the generated request for Life Insurance Options. The request may then be transmitted to one or more Life Insurance Option providers 110. The Life Insurance Option providers 110 may then identify Life Insurance Options for purchase by the consumer 102 and return the option data to the processing server 108, which may be received by the receiving unit 202.

In some non-limiting embodiments, the processing unit 204 of the processing server 108 may be programmed and/or configured to identify, calculate, and/or generate Life Insurance Options for the consumer 102 based at least partially on the consumer data. In such an embodiment, the processing unit 204 may use a zero lapse adjusted method for the calculation of a premium for each Life Insurance Option. For example, the systems and methods described in U.S. patent application Ser. No. 14/095,225, entitled “System and Method for Calculating a Premium for a Life Insurance Option,” the entirety of which is hereby incorporated by reference, may be used to calculate the premiums. In some instances, the processing unit 204 may calculate the premium for Life Insurance Options on behalf of one or more Life Insurance Option providers 110, such as by using mortality rate data provided by each respective Life Insurance Option provider 110.

In a preferred and non-limiting embodiment, the processing unit 204 may store the received option data as Life Insurance Options 214 in a life insurance database 212. The life insurance database 212 may be local or remote to the processing unit 204, and may include one or more suitable data structures for storing and organizing data relating to life insurance policies and/or Life Insurance Options. Each Life Insurance Option 214 may include at least a premium, a period of coverage, and an effective date for the option, which may correspond to a later date from the date at which the option is requested (e.g., the start date), at which time the consumer 102 may exercise the option and purchase a policy according to the terms of the option. Each Life Insurance Option 214 may include additional data such as, but not limited to, a predicted risk class, terms and conditions, reserve amounts, etc.

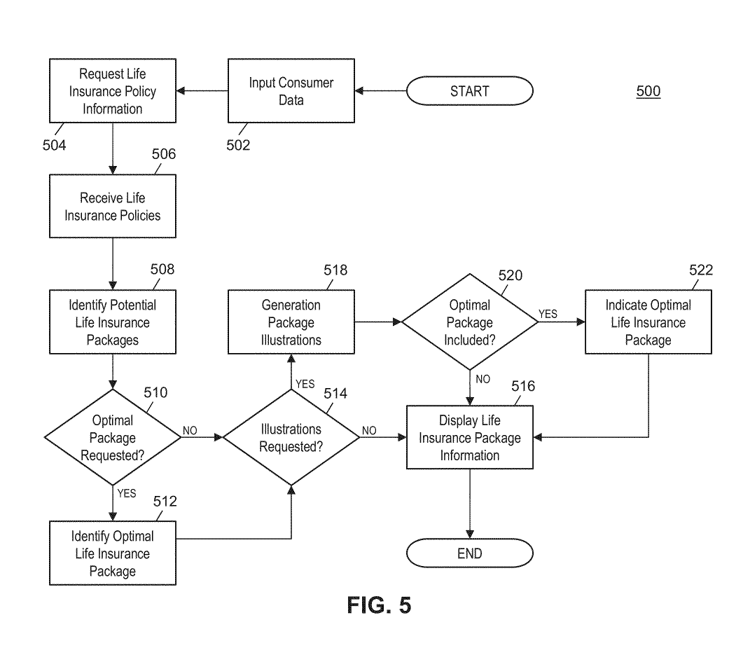

The processing unit 204 may be further programmed and/or configured to generate a visual representation, such as a policy illustration, for each identified Life Insurance Option 214. The illustration may include, for example, the premium, effective date, period of coverage, and/or any other suitable data associated with the respective Life Insurance Option 214 that may be beneficial for presentation to the consumer 102 and/or agent 104 for the selection and purchase of a Life Insurance Option 214. The illustration may be formatted in any suitable format, such as a chart, a graph, a table as illustrated in FIG. 5 and discussed below, or any other format as will be apparent to persons having skill in the relevant art. The transmitting unit 206 may be programmed and/or configured to transmit the generated illustrations to the computing device 106.

In instances where the request for Life Insurance Option illustrations may include a request for an optimal Life Insurance Option to be identified, the processing unit 204 may identify an optimal Life Insurance Option 214 of the Life Insurance Options 214 identified and stored in the life insurance database 212. Identification of an optimal Life Insurance Option may be based on at least the premium for each Life Insurance Option 214 and any other additional data that may be suitable as will be apparent to persons having skill in the relevant art. In some non-limiting embodiments, data used for identification of an optimal Life Insurance Option 214 may be dependent on the request for Life Insurance Options received by the receiving unit 202. For example, the request may indicate a preference for period of coverage over premium amount, which may be used accordingly by the processing unit 204 in identifying one or more optimal Life Insurance Options 214. The processing unit 204 may indicate in the generated visual representation of the optimal Life Insurance Option(s) 214 its identification as the optimal Life Insurance Option 214.

Identification of an optimal Life Insurance Option 214 may include the application of one or more algorithms, which may utilize the option data included in each Life Insurance Option 214 and the data included in the request received by the receiving unit 202. The algorithms may be stored in a memory 218 that is in communication with the processing unit 204 or may be stored elsewhere. As an example, the memory 218 may include one or more software applications that are executable by the processing unit 204. The memory 218 may also be configured to store data for use by the processing server 108 in performing the functions disclosed herein. For example, the memory 218 may include software applications, algorithms, and/or various data structures for use in calculating premiums for Life Insurance Options 214 in embodiments where the processing unit 204 is programmed and/or configured to identify the Life Insurance Options 214 without the use of an outside Life Insurance Option provider 110.

In instances where other and/or additional types of life insurance policies are also requested, the processing unit 204 may be programmed and/or configured to identify one or more life insurance policies for purchase by the consumer 102. Identification of life insurance policies may include the calculation and/or determination of life insurance policy data by the processing unit 204 and/or the requesting of life insurance policies from one or more life insurance policy providers 112. In instances where policy data may be requested from life insurance policy providers 112, the transmitting unit 206 may transmit a request for life insurance policies to the providers 112, and the receiving unit 202 may receive the life insurance policies.

In preferred and non-limiting embodiments, the processing unit 204 may store received life insurance policy data as life insurance policies 216 in the life insurance database 212. As explained above, the processing unit 204 may also be programmed and/or configured to generate visual representations, such as policy illustrations, for each of the life insurance policies 216. The illustrations may include the premium, policy type, period of coverage, and/or any other additional data that may be suitable as will be apparent to persons having skill in the relevant art. The processing unit 204 may also be programmed and/or configured to match life insurance policies 216 to Life Insurance Options 214. In some instances, life insurance policies 216 may be matched to Life Insurance Options 214 where there is a correspondence between the exercise date of the Life Insurance Options 214 and the period of coverage of the life insurance policies 216. In other instances, life insurance policies 216 may be matched to Life Insurance Options 214 based on the premiums.

The processing unit 204 may be further programmed and/or configured to identify an optimal life insurance package. The optimal life insurance package may include a matched Life Insurance Option 214 and life insurance policy 216 available for purchase by the consumer 102, or any other combination of life insurance policies and/or Life Insurance Options, that may be considered optimal for the consumer 102 based on one or more considerations, such as amount of the policy, total period of coverage, riders, exclusions, coverage types, premium amounts, and other considerations that will be apparent to persons having skill in the relevant art. In some instances, the life insurance policies included in the optimal life insurance package may not have been previously matched by the processing unit 204. In some embodiments, the processing unit 204 may indicate in the visual representations generated for the policies included in the optimal life insurance package that the respective policies are part of the optimal life insurance package.

In non-limiting embodiments where the processing server 108 and the computing device 106 may be a single device, the processing server 108 may further include an input unit 208 and a display unit 210 that are in communication with the processing unit 204. The input unit 208 may be configured to receive input from a user, such as input from the agent 104 of consumer data associated with the consumer 102. For example, the agent 104 may enter data associated with the consumer 102, such as the consumer's age, risk class information, desired criteria for optimal Life Insurance Options, policies, or packages, etc. via the input unit 208. The input unit 208 may be any type of input device suitable for performing the functions as disclosed herein, such as a keyboard, mouse, click wheel, touch display, microphone, camera, and/or the like.

The display unit 210 may be configured to display data to one or more users. For example, the display unit 210 may display a GUI to the agent 104 for the input of data using the input unit 208, such as to input consumer data and request Life Insurance Options, packages, and/or visual representations thereof. The display unit 210 may also display visual representations for Life Insurance Options 214 and/or life insurance policies 216 generated by the processing unit 204 and identified optimal Life Insurance Options or packages. The display unit 210 may be further configured to display any additional data suitable for performing the functions disclosed herein as will be apparent to persons having skill in the relevant art.

The processing server 108 may further include additional units for performing the functions disclosed herein, in addition to traditional functions of a processing server 108 and/or computing device 106. For example, the processing server 108 may include additional memory or communications interfaces, removable storage devices, additional processing units, and/or other such units as will be apparent to persons having skill in the relevant art.

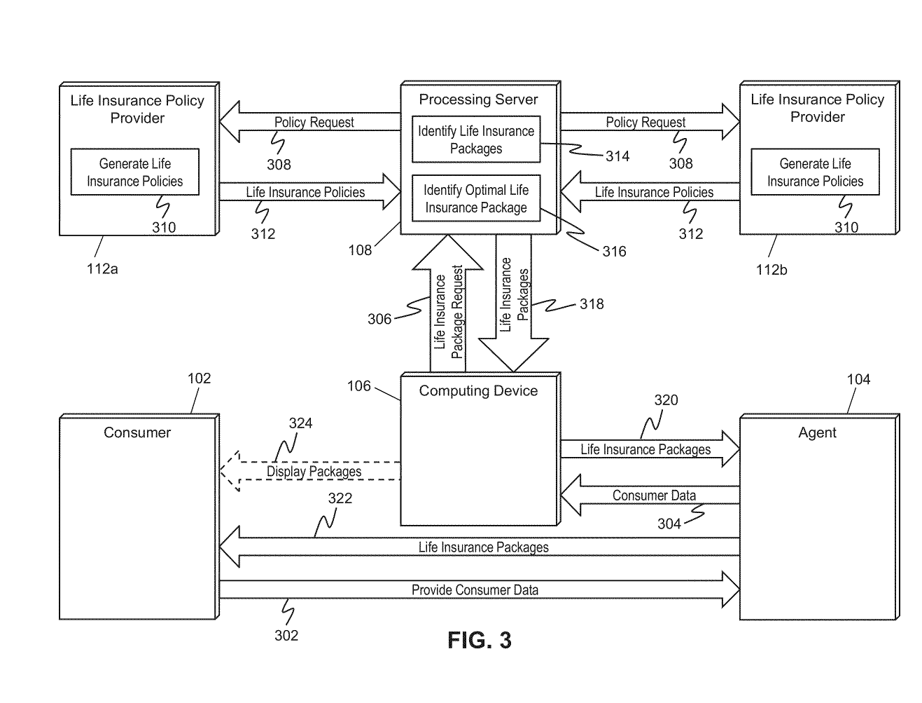

FIG. 3 is an illustration of a process for the generation of optimal life insurance packages of life insurance policies using the system 100 of FIG. 1 and according to a preferred and non-limiting embodiment.

In step 302, the consumer 102 may visit the agent 104 and may provide consumer data for use in obtaining a package of two or more life insurance policies. The consumer data may include at least an age for the consumer 102, and any additional data that may be used by the agent 104 for the identification of a risk class associated with the consumer 102. The consumer data may also include requested criteria for the identification of an optimal life insurance package, such as requested premiums, coverage types, coverage amount, exclusions, etc. In some embodiments, the data provided to the agent 104 may be for a person other than the consumer 102, such as if the consumer 102 is requesting insurance for another person (e.g., a spouse, employee, etc.). However, as explained above, the consumer data may be input, identified, and/or obtained in various ways and from various parties.

In step 304, the agent 104 may enter the consumer data into the computing device 106. In one embodiment, the agent 104 may identify a risk class for the consumer 102 based on the provided information and may include the identified risk class in the consumer data entered into the computing device 106. In another embodiment, the agent 104 may enter the information provided by the consumer 102 into the computing device 106, and the computing device 106 may identify a risk class associated with the consumer 102 based thereon.

In step 306, the computing device 106 may submit a request for an optimal life insurance package to the processing server 108, which may be received by the receiving unit 202 of the processing server 108. The request may include, for example, the age of the consumer 102, the identified risk class associated with the consumer 102, and any provided criteria for optimization. In some embodiments, the request may also include a start date, which may be the current date at the time of the request or the date at which a purchased life insurance policy would be effective. In other embodiments, the processing unit 204 of the processing server 108 may identify the start date based on the life insurance policy, the consumer data, an existing life insurance policy, and/or the like.

In step 308, the transmitting unit 206 of the processing server 108 may transmit a request for life insurance policies to one or more life insurance policy providers 112. The request may include at least the age and risk class associated with the consumer 102. In step 310, the life insurance policy providers 112 may generate life insurance policies 216 for the consumer 102 based on the data using methods or systems that will be apparent to persons having skill in the relevant art. In step 312, the life insurance policy providers 112 may transmit the life insurance policies 216 to the processing server 108, which may be received by the receiving unit 202. The life insurance policies 216 may include premiums, effective dates, periods of coverage, coverage amounts, coverage types, exclusions, riders, etc. The life insurance policies 216 may include options, policies with or without riders, and/or other types of life insurance policies 216.

In step 314, the processing unit 204 of the processing server may identify life insurance packages of two or more life insurance policies 216. The life insurance packages may include any two or more life insurance policies 216, or may be identified based on correspondences in details of each of the included life insurance policies 216. For example, if the two or more insurance policies 216 include a term policy and an option, the package may include a term policy that has an end date corresponding to the start date of the option. In another example, the two or more policies may each include a similar coverage amount or premium.

In step 316, the processing unit 204 of the processing server 108 may identify an optimal life insurance package including two or more life insurance policies 216 based on the details of the included life insurance policies 216 and the criteria provided in the life insurance package request. In step 318, the transmitting unit 205 of the processing server 108 may transmit the generated life insurance packages, including the optimal life insurance package, to the computing device 106. In step 320, the computing device 106 may display the received life insurance packages to the agent 104, consumer 102, or other individual for viewing and selection of a life insurance package for purchase.

In step 322, the agent 104 or other individual may view the package data and may relay the information to the consumer 102. In step 324, the consumer 102 may view the package data directly from the computing device 106, such as via the display unit 210 displaying the data to both the agent 104 and the consumer 102. It will be apparent to persons having skill in the relevant art that these steps, including but not limited to step 324, may be entirely optional and are only exemplary of a non-limiting embodiment. The agent 104 and consumer 102 may then select and purchase a life insurance package using methods and systems that will be apparent to persons having skill in the relevant art.

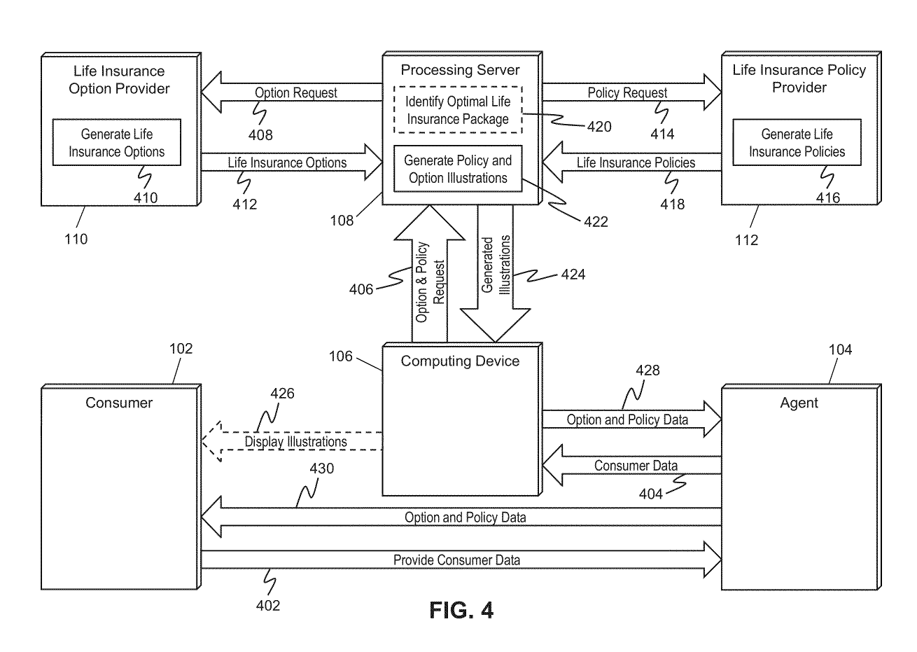

FIG. 4 is an illustration of a process for generating visual representations, including but not limited to illustrations, for Life Insurance Options and policies, and the distribution thereof, using the system 100 of FIG. 1 and in accordance with a preferred and non-limiting embodiment.

In step 402, the consumer 102 may visit the agent 104 and may provide consumer data for use in obtaining a Life Insurance Option and policy. The consumer data may include at least an age for the consumer 102 and any additional data that may be used by the agent 104 for the identification of a risk class associated with the consumer 102. In step 404, the agent 104 may enter the consumer data into the computing device 106. In some embodiments, the agent 104 may identify a risk class for the consumer 102 based on the provided information, and may include the identified risk class in the consumer data entered into the computing device 106. In other embodiments, the agent 104 may enter the information provided by the consumer 102 into the computing device 106, and the computing device 106 may identify a risk class associated with the consumer 102 based thereon. Further, as described above, the consumer 102 or other individual may directly input consumer data into a GUI.

In step 406, the computing device 106 may submit a request for visual representations, such as but not limited to illustrations, of one or more Life Insurance Options and life insurance policies to the processing server 108, which may be received by the receiving unit 202 of the processing server 108. The request may include, for example, the age of the consumer 102 and the risk class associated with the consumer 102. In some embodiments, the request may also include a start date, which may be the current date at the time of the request or the date at which a purchased life insurance policy would be effective. In other embodiments, the processing unit 204 of the processing server 108 may identify the start date.

In step 408, the transmitting unit 206 of the processing server 108 may transmit a request for Life Insurance Options to one or more Life Insurance Option providers 110. The request may include, for example, the age and risk class associated with the consumer 102. In step 410, the Life Insurance Option providers 110 may generate Life Insurance Options 214 for the consumer 102 based on the data using various methods or systems such as, for example, a zero-lapse adjusted method for calculating Life Insurance Option premiums. For example, the systems and methods described in U.S. patent application Ser. No. 14/095,225, entitled System and Method for Calculating a Premium for a Life Insurance Option, the entirety of which is hereby incorporated by reference, may be used to calculate the premiums. In step 412, the Life Insurance Option providers may transmit the Life Insurance Options 214 to the processing server 108, which may be received by the receiving unit 202. The Life Insurance Options 214 may include, for example, a premium, an effective date, and a period of coverage.

In step 414, the transmitting unit 206 of the processing server 108 may transmit a request for life insurance policies to one or more life insurance policy providers 112. The request may include the age and risk class associated with the consumer 102, as examples. In step 416, the life insurance policy providers 112 may generate life insurance policies 216 for the consumer 102 based on the data using methods or systems that will be apparent to persons having skill in the relevant art. In step 418, the life insurance policy providers 112 may transmit the life insurance policies 216 to the processing server 108, which may be received by the receiving unit 202. The life insurance policies 216 may include, for example, a premium, policy type, and period of coverage.

In step 420, the processing unit 204 of the processing server 108 may identify an optimal life insurance packing including at least one Life Insurance Option 214 and at least one life insurance policy 216. In some instances, one or more Life Insurance Options 214 and life insurance policies 216 in the package may be matched based on one or more included criteria. It will be apparent to persons having skill in the relevant art that all of these steps, including but not limited to step 320, may be entirely optional. In step 422, the processing unit 204 may generate visual representations, such as illustrations, for each of the received Life Insurance Options 214 and life insurance policies 216. The visual representations may include the data included in each respective Life Insurance Option 214 and life insurance policy 216, such as the premium and period of coverage. In instances where an optimal life insurance package is identified, the visual representation for the Life Insurance Option 214 and life insurance policy 216 included in the package may indicate the Life Insurance Option 214 and life insurance policy 216 as being included in the package.

In step 424, the transmitting unit 205 of the processing server 108 may transmit the generated visual representations to the computing device 106. In step 426, the computing device 106 may display the received visual representations to the consumer 102 for viewing and selection of a Life Insurance Option 214 or life insurance package for purchase. It will be apparent to persons having skill in the relevant art that the visual representations may be displayed in various ways and that, in some embodiments, may not be displayed at all.

In step 428, the agent 104 or other individual may view the option data and policy data for the respective identified Life Insurance Options 214 and life insurance packages 216 via the received visual representations. In step 430, the agent 104 or other individual may share the option data and policy data with the consumer 102 for the identification of a Life Insurance Option 214 or life insurance package for purchase. The agent 104, consumer 102, and/or other individual may then select and purchase a Life Insurance Option 214 and/or life insurance policy 216 using methods and systems that will be apparent to persons having skill in the relevant art.

FIG. 5 illustrates a process 500 for the identification of an optimal life insurance package of two or more life insurance policies 216 based on a received request for a life insurance package for the consumer 102 in accordance with a preferred and non-limiting embodiment.

In step 502, consumer data associated with the consumer 102 may be input into the processing server 108, such as via the input unit 208, or received by the receiving unit 202. As described above, the consumer data may include various parameters, characteristics, preferences, and/or values such as, for example, an age, a consumer risk class of a plurality of risk classes, and a plurality of consumer characteristics. In some embodiments, the consumer risk class may be identified by the processing unit 204 of the processing server 108 based on the plurality of consumer characteristics. The plurality of consumer characteristics may also include criteria used for the identification of an optimal life insurance package.

In step 504, the transmitting unit 206 of the processing server 108 may transmit a request for life insurance policy information to one or more life insurance policy providers 112. In step 506, the receiving unit 202 may receive life insurance policies 216 from the life insurance policy providers 112. In some embodiments, the received life insurance policies 216 may include one or more Life Insurance Options. The received life insurance policies 216 may also include policies 216 with or without riders or exclusions, such as a life insurance policy 216 with a rider and the same life insurance policy 216 without a rider. It will be appreciated that various other combinations are possible.

In step 508, the processing unit 204 may identify potential life insurance packages. The packages may include any combination of two or more life insurance policies 216, or may include combinations of two or more life insurance policies 216 based on specific matching criteria. For example, the specific matching criteria may include coverage dates (e.g., corresponding start and end dates, corresponding terms, etc.), coverage types (e.g., as requested by the consumer 102, a term policy and an option, etc.), coverage amounts (e.g., equal coverage, total combined coverage, etc.), or other suitable criteria as will be apparent to persons having skill in the relevant art.

In step 510, the processing unit 204 may determine if identification of a life insurance package that is optimal for the consumer 102 is requested. If an optimal package is requested, then, in step 512, the processing unit 204 may identify one of the potential life insurance packages as being an optimal package. Identification of the optimal package may be based on the details of the included two or more insurance policies 216 as compared and/or corresponded to the plurality of consumer characteristics included in the request. For example, the processing unit 204 may apply an algorithm (e.g., as stored in the memory 218 or part of a software application) to each life insurance package that may rate (e.g., score) the packages based on the requested criteria of the consumer 102, and may identify an optimal package accordingly. In some instances, the requested criteria of the consumer 102 may be weighted, such as to provide higher priority for specific criteria. For instance, the consumer 102 may request a coverage amount of $500,000, but may place more importance on ensuring a total premium below a specific amount. In such examples, the criteria may be weighted by numerical value, ranking of importance, and/or the like.

Once an optimal life insurance package has been identified, or if one is not requested, then, in step 514, the processing unit 204 may determine if visual representations, such as illustrations, of the life insurance packages are requested. If no visual representations are requested, then, in step 516, the life insurance packages may be displayed to the agent 104, consumer 102, and/or other individual via the display unit 210. If visual representations are requested, then, in step 518, the processing unit 204 may generate visual representations of each of the life insurance packages. In some embodiments, the visual representations may be generated as illustrations pursuant to life insurance illustration model regulations, such as the model law 582. Such illustrations may include, for example, the premium amounts, coverage types, coverage amounts, and start and/or end dates for the included two or more policies and/or for the package as a whole.

In step 520, the processing unit 204 may determine if an optimal package has been identified. If no optimal package has been identified, then the process may proceed to step 516 where the life insurance packages and their corresponding illustrations may be displayed to the agent 104, consumer 102, and/or other individual. If an optimal package has been identified, then, in step 522, the generated visual representations may be modified as to indicate the optimal life insurance package as being optimal compared to the other packages. For example, an accompanying illustration may include some form of identifier (e.g., a highlight, an icon, etc.) to indicate the optimal life insurance package. Then, proceeding to step 516, the life insurance packages and visual representations, including the indication of the optimal life insurance package as being optimal, may be displayed to the agent 104, consumer 102, and/or other individual.

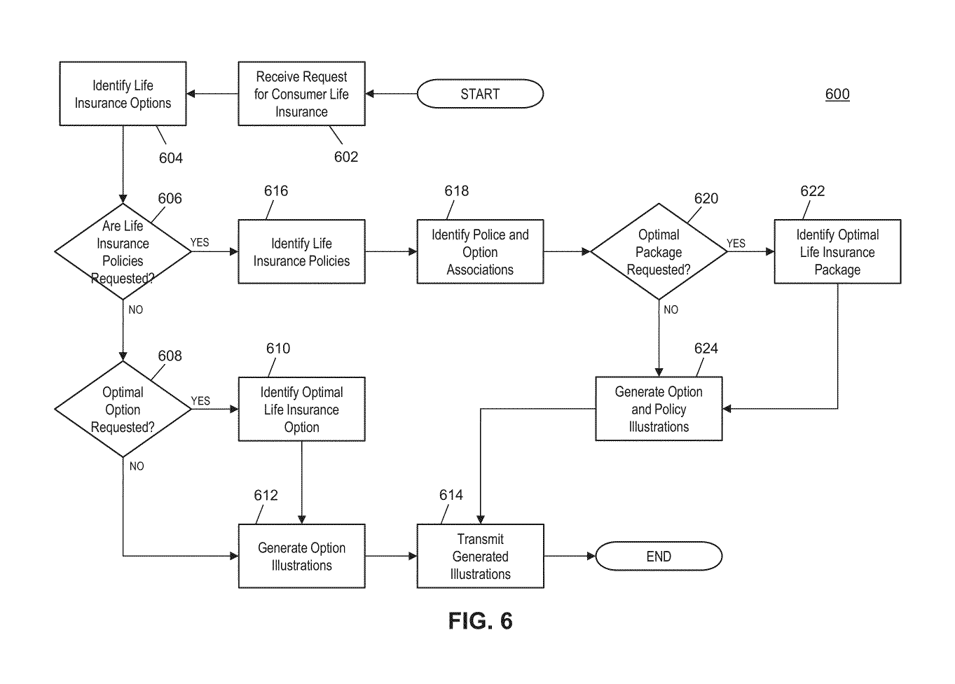

FIG. 6 illustrates a process 600 for the generation and transmission of visual representations of Life Insurance Options 214 and life insurance policies 216 based on a received request for option and policy data for a consumer 102 in accordance with a preferred and non-limiting embodiment.

In step 602, the receiving unit 202 of the processing server 108 may receive a request for consumer life insurance from the computing device 106. The request may include, for example, an age and risk class associated with the consumer 102. The request may include a request for one or more Life Insurance Options, and may also include a request for one or more life insurance policies and a request for one or more optimal Life Insurance Options or packages to be identified.

In step 604, the processing unit 204 may identify Life Insurance Options 214 for the consumer 102, which may correspond to guarantees of future insurability of the consumer 102 at a later date and include at least a period of coverage, the later date, and a premium for the Life Insurance Option 214 calculated based at least partially on the consumer's risk class and their age at the later date, as an example. In step 606, the processing unit 204 may determine if life insurance policies are also requested, based on information included in the received consumer life insurance request. If no life insurance policies are requested, then, in step 608, the processing unit 204 may further identify if identification of an optimal Life Insurance Option 214 is requested, based on information included in the received consumer life insurance request.

If an optimal Life Insurance Option 214 is requested, then, in step 410, the processing unit 204 may identify an optimal Life Insurance Option 214 from the identified Life Insurance Options 214 based at least partially on, for example, the calculated premium for each respective Life Insurance Option 214. Once the optimal Life Insurance Option 214 has been identified, or if no determination of an optimal option is requested, then, in step 612, the processing unit 204 may generate visual representations for each of the identified Life Insurance Options 214, each illustration including at least the premium, later date, and period of coverage for the respective Life Insurance Option 214. The transmitting unit 206 of the processing server 108 may then transmit the generated visual representations to the computing device 106 for display to the consumer 102 or other individual for selection of a Life Insurance Option 214, in step 614.

If, in step 606 of the process, the processing unit 204 determines that life insurance policies are requested in the request for consumer life insurance, then, in step 616, the processing unit 204 may identify life insurance policies 216 for the consumer 102 based at least partially on, for example, the age and risk class associated with the consumer 102. Each identified life insurance policy 216 may include at least a premium, a policy type, and a period of coverage. In step 618, the processing unit 204 may identify associations between the identified Life Insurance Options 214 and the identified life insurance policies 216. In one embodiment, the associations may be based on the period of coverage for life insurance policies 216 and the later date for the Life Insurance Options 214.

In step 620, the processing unit 204 may determine if the request for consumer life insurance includes a request to identify an optimal life insurance package. If the identification of an optimal life insurance package is requested, then, in step 622, the processing unit 204 may identify an optimal life insurance package including a Life Insurance Option 214 and associated life insurance policy 216 that is identified as optimal based on at least the premiums calculated for the included Life Insurance Option 214 and life insurance policy 216. Once the optimal life insurance package has been identified, or if no optimal package was requested, then, in step 624, the processing unit 204 may generate visual representations for each of the Life Insurance Options 214 and life insurance policies 216 including the respective data in each of the options 214 or policies 216. Then, the process 600 may proceed to step 614, where the generated illustrations are transmitted to the computing device 106 for display to the consumer 102 or other individual.

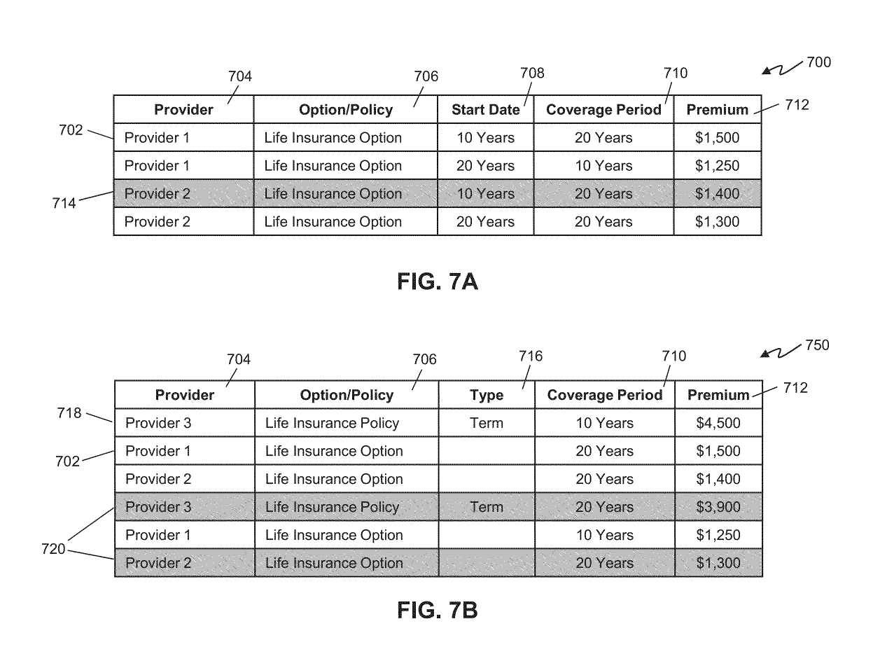

FIGS. 7A and 7B are diagrams of exemplary visual representations 700, 750 of Life Insurance Options 214 for display to a consumer 102 or agent 104 for use in purchasing Life Insurance Options in accordance with a preferred and non-limiting embodiment. The visual representations shown in FIGS. 7A and 7B are depicted as illustrations. It will be apparent to persons having skill in the relevant art that the illustrations depicted in FIGS. 7A and 7B are provided as an example only, and that other formatting and configuration of the illustrations depicted therein and discussed below may be generated by the systems and method as discussed herein, as will be apparent to persons having skill in the relevant art.

As illustrated in FIG. 7A, in some non-limiting embodiments, the illustrations generated by the processing unit 204 of the processing server 108 and transmitted to the computing device 106 for display to the consumer 102 or other individual may be formatted in a table 700. The table 700 may display a plurality of Life Insurance Option illustrations 702. Each Life Insurance Option illustration 702 may include, for example, a provider 704, an indication 706 of the associated insurance item being an option or a policy, a start date 708, a period of coverage 710, and a premium 712. The provider 704 may be a Life Insurance Option provider 110 or other suitable entity. The indication 706 may be used for clarification to the consumer 102 of the type of insurance item illustrated. The start date 708 may be the exercise date of the corresponding option. The period of coverage 710 may be the period of coverage that a policy purchased using the corresponding option would be effective.

In some embodiments, the processing unit 204 may indicate a specific Life Insurance Option illustration 702 as corresponding to an optimal Life Insurance Option, such as the Life Insurance Option illustration 714 illustrated in FIG. 7A. In the example illustrated in FIG. 7A, the Life Insurance Option illustration 714 has a different background to separate it from the other illustrations 702, and to indicate to the consumer 102 that it corresponds to an identified optimal Life Insurance Option. Additional methods for indicating an optimal Life Insurance Option will be apparent to persons having skill in the relevant art and may include, for example, modifying a background color or a text color, adding an icon or graphic, highlighting text, and/or the like.

In some embodiments, the processing unit 204 of the processing server 108 may generate visual representations for both Life Insurance Options 214 and life insurance policies 216. In such an embodiment, the visual representations may be in the form of illustrations and may be included in a single table, such as the table 770 illustrated in FIG. 7B. The table 770 may include life insurance policy illustrations 718 in addition to Life Insurance Option illustrations 702. The table 770 may include a policy type 716, which may indicate the type of policy of the life insurance policy 216 corresponding to each life insurance policy illustration 718.

As illustrated in FIG. 7B, the insurance items may be separated based on associations between life insurance policies 216 and Life Insurance Options 214. For example, in the example illustrated in FIG. 7B, each life insurance policy illustration 718 is accompanied by Life Insurance Option illustrations 702 that have a start date 708 corresponding to the period of coverage 710 for the corresponding life insurance policy 216. In embodiments where the processing unit 204 may identify an optimal life insurance package, the table 770 may also indicate the Life Insurance Option 214 and life insurance policy 216 included in the optimal life insurance package in the corresponding illustrations, such as in the illustrations 720.

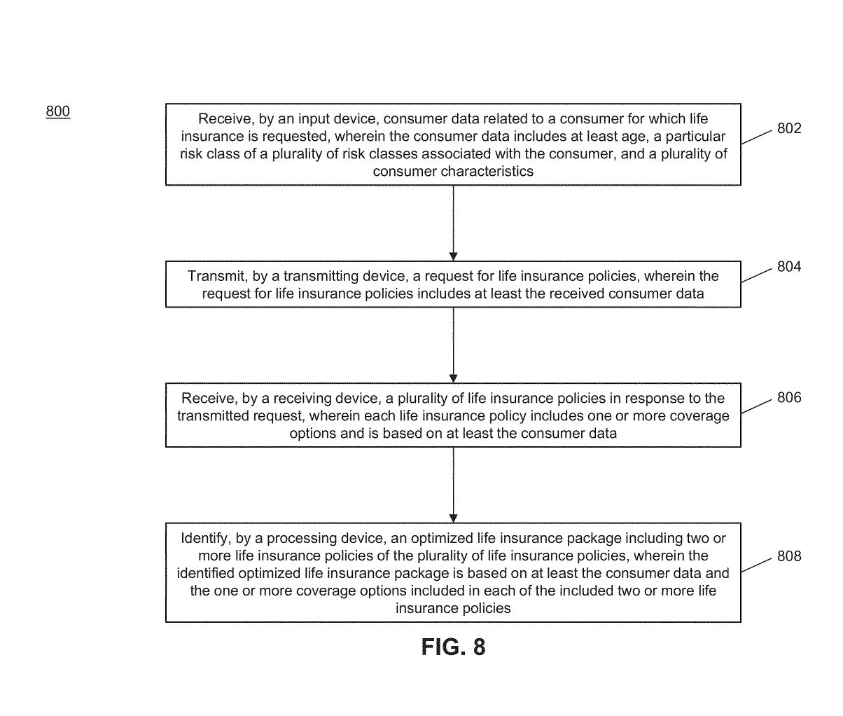

FIG. 8 is a flow chart of a method 800 for generating an optimized life insurance package of life insurance policies based on consumer characteristics and in accordance with a preferred and non-limiting embodiment of the present invention.

In step 802, consumer data related to a consumer (e.g., the consumer 102) for which life insurance is requested may be received by an input device (e.g., the input unit 208), wherein the consumer data includes at least an age, a particular risk class of a plurality of risk classes associated with the consumer 102, and a plurality of consumer characteristics. It will be appreciated that, as described above, the consumer data may include other parameters, characteristics, preferences, and/or values. In some non-limiting embodiments, the consumer characteristics may include one or more optimization factors such as, but not limited to, at least one of: option cost, premium cost, cash flow, coverage amount, coverage length, exclusion preferences, and policy type.

In step 804, a request for life insurance policies (e.g., life insurance policies 216) may be transmitted by a transmitting device (e.g., the transmitting unit 206), wherein the request for life insurance policies 216 includes at least the received consumer data. In step 806, a plurality of life insurance policies 216 may be received by a receiving device (e.g., the receiving unit 202) in response to the transmitted request, wherein each life insurance policy 216 includes one or more coverage options and is based at least partially on at least the consumer data. In some embodiments, at least one life insurance policy 216 of the plurality of life insurance policies 216 may be a Life Insurance Option (e.g., Life Insurance Option 214).

In step 808, an optimized life insurance package including two or more life insurance policies 216 of the plurality of life insurance policies 216 may be identified by a processing device (e.g., the processing unit 204), wherein the identified optimized life insurance package is based on at least the consumer data and the one or more coverage options included in each of the included two or more life insurance policies 216. In some embodiments, at least one of the two or more life insurance policies 216 may be a Life Insurance Option 214.

In non-limiting embodiments, the method 800 may further include: generating, by the processing device 204, a plurality of life insurance packages, wherein each generated life insurance package includes a unique combination of two or more life insurance policies 216 of the received plurality of life insurance policies 216; and generating, by the processing device 204, a visual representation, such as an illustration, of each life insurance package of the generated plurality of life insurance packages, wherein each generated visual representation includes at least the one or more coverage options included in each of the two or more life insurance policies 216 included in the respective life insurance package. In some embodiments, the method 800 may also include displaying, by a display device (e.g., the display unit 210), the generated visual representation of each life insurance package of the generated plurality of life insurance packages. In some embodiments, the illustration of the identified optimized life insurance package may be identified as being associated with the identified optimized life insurance package.

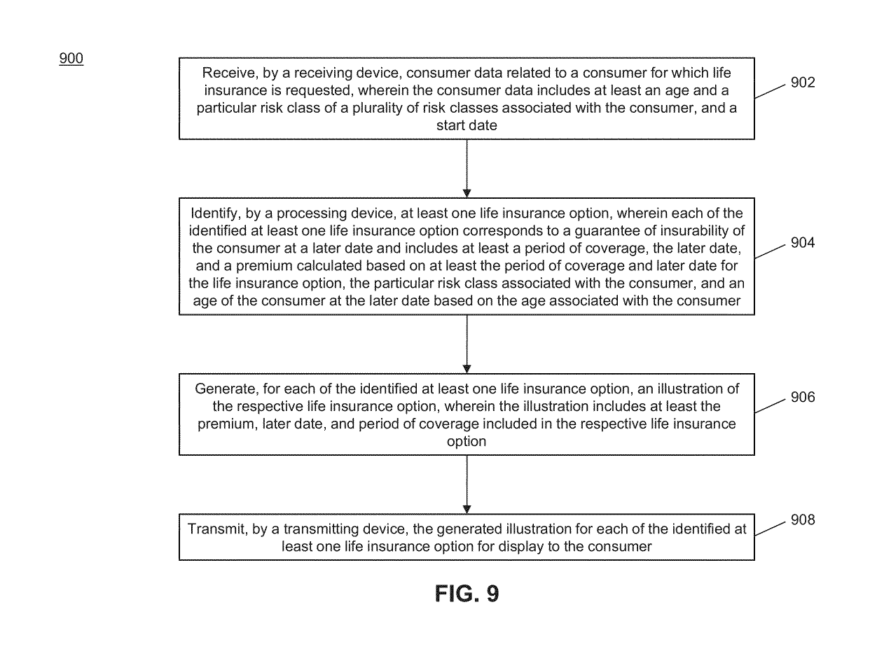

FIG. 9 is a flow chart of a method 900 for illustrating Life Insurance Options for purchase by a consumer (e.g., the consumer 102) in accordance with a preferred and non-limiting embodiment.

In step 902, consumer data related to the consumer 102 for which life insurance is requested may be received by a receiving device (e.g., the receiving unit 202), wherein the consumer data includes, for example, at least an age and a particular risk class of a plurality of risk classes associated with the consumer 102, and a start date. It will be appreciated that, as described above, the consumer data may include other parameters, characteristics, preferences, and/or values.

In step 904, at least one Life Insurance Option (e.g., the Life Insurance Option 214) may be identified by a processing device (e.g., the processing unit 204), wherein the each of the at least one identified Life Insurance Option 214 corresponds to a guarantee of insurability of the consumer 102 at a later date and includes at least a period of coverage, the later date, and a premium calculated based on at least the period of coverage and later date for the Life Insurance Option 214, the particular risk class associated with the consumer 102, and an age of the consumer 102 at the later date based on the age associated with the consumer 102.

In some embodiments, the later date included in each of the identified at least one Life Insurance Options 214 may be one of a plurality of later dates. In some embodiments, the period of coverage included in each of the identified at least one Life Insurance Options 214 may be one of a plurality of periods of coverage. In one embodiment, each of the identified at least one Life Insurance Options 214 may include a unique combination of later date and period of coverage.

In step 906, a visual representation may be generated, for each of the identified at least one Life Insurance Option 214, of the respective Life Insurance Option 214 and including at least the premium, later date, and period of coverage included in the respective Life Insurance Option. In step 908, the generated visual representation for each of the identified Life Insurance Option 214 may be transmitted, by a transmitting device (e.g., the transmitting unit 206), for display to the consumer 102 or other individual.

In some non-limiting embodiments, the method 900 may further include: identifying, by the processing device 204, an optimal Life Insurance Option of the identified at least one Life Insurance Options 214 based on at least one of: the premium, later date, and period of coverage for each respective Life Insurance Option; and indicating, in the visual representation generated for the identified optimal Life Insurance Option, the respective Life Insurance Option 214 as being identified as the optimal Life Insurance Option.

In some non-limiting embodiments, the method 900 may further include: identifying, by the processing device 204, at least one life insurance policy (e.g., the life insurance policy 216), wherein each of the identified at least one life insurance policy 216 corresponds to insurability of the consumer 102 at the start date and includes at least a period of coverage, a policy type, and a premium calculated based on at least the period of coverage and policy type for the life insurance policy 216 and the age and particular risk class associated with the consumer 102; and generating, for each of the identified at least one insurance policy 216, a visual representation of the respective life insurance policy 216, wherein the visual representation includes at least the premium, policy type, and period of coverage included in the respective life insurance policy 216. In a further embodiment, the transmitting step 908 may further include transmitting the generated visual representation for each of the at least one life insurance policy 216. In another further embodiment, the period of coverage for each of the at least one life insurance policy may correspond to a period between the start date and the later date.

In some non-limiting embodiments, the method 900 may further include: associating, by the processing device 204, each of the at least one life insurance policies 216 with at least one matching Life Insurance Option 214 where the later date of each of the at least one matching Life Insurance Option 214 corresponds to a date from the start date and after the period of coverage included in the respective at least one life insurance policy 216. In an even further embodiment, the method 900 may include: indicating, in the generated illustration for each of the identified at least one life insurance policy 216, the associated at least one matching Life Insurance Option 214.

In non-limiting embodiments, a match between at least one life insurance policy and at least one Life Insurance Option may be determined by applying one or more matching algorithms. As an example, the match may be determined by creating associations between a plurality of life insurance policies and a plurality of Life Insurance Options, where each life insurance policy corresponds to eligibility requirements (e.g., parameters, criteria, and/or characteristics of the policy that may be satisfied by certain consumer data). A plurality of life insurance policies may then be identified that the consumer is eligible for. At least one life insurance policy and at least one Life Insurance Option may then be identified based on the associations between the policies and the options.

In further non-limiting embodiments, the method 900 may further include: identifying, by the processing device 204, an optimal life insurance package for the consumer 102, wherein the optimal life insurance package includes a specific life insurance policy 216 of the identified at least one life insurance policy 216 and a specific matching Life Insurance Option 214 of the at least one matching Life Insurance Option 214 associated with the specific life insurance policy 216, based on at least one of: the premium, policy type, and period of coverage for the specific life insurance policy 216 and the premium and period of coverage for the specific matching Life Insurance Option. In a further embodiment, the method 900 may also include: indicating, in the illustration generated for each of the specific life insurance policy 216 and the specific matching Life Insurance Option 214, the respective life insurance policy 216 and Life Insurance Option 214 as being included in the identified optimal life insurance package.

In non-limiting embodiments, questions may be presented to a user and, based on the responses to the questions, one or more life insurance plans, one or more Life Insurance Options, or an optimized life insurance package may be generated based on the responses to the questions. Such a questionnaire may be provided by the system or, in other examples, may be provided by third parties such that the system interfaces with third-party systems. For example, investment questionnaires for gathering client profile data relevant to making retirement portfolio decisions or other investment decisions may include questions that factor into a recommendation for life insurance. It will be appreciated that such client profile data may be collected through any type of questionnaire. A set of rules and process flows may be implemented to specify multiple choice options or other answer criteria, order and navigability of questions (e.g., including rules for hiding and/or skipping questions, as an example), validity of answers, error conditions, defaults, help information, and/or the like. As an example, the set of rules and the process flow may specify an appropriate next question to present based on a particular response. In this way, the questionnaire is dynamically reconfigured in the process of being answered in order to collect the appropriate data.

Such a questionnaire and a corresponding set of rules allow for data to be collected that may be analyzed according to one or more calculations, mathematical models, weighting rules, and/or the like, in order to determine whether additional insurance is required or recommended for a particular individual. The responses to the questionnaires and the corresponding set of rules and calculations may then trigger recommendations and, for example, the display of dialog windows, user interfaces, and/or the like. The amount of insurance recommended, if any, may be optimized based on a human capital hedge, a determination of what insurance plan(s) best meets participant needs, and a determination of whether any future participant insurance is required, as examples. Participants' future insurance needs may be satisfied by a recommendation for one or more insurance plans at the time the determinations are made, or a participant may also lock-in the then-current underwriting risk assessment and purchase Life Insurance Option(s).

As an example, calculations and algorithms for analyzing responses to questionnaires may be identified and mapped to different question responses through the use of a spreadsheet or other data structure and corresponding logic. There may be, as an example, four different possible insurance determinations: (1) no insurance is recommended, (2) insurance plan(s) are recommended but not a Life Insurance Option, (3) insurance plan(s) are recommended including a Life Insurance Option, or (4) an optimized life insurance package is recommended. For example, it can be determined that no insurance is recommended if the calculations and algorithms may determine that the participant's existing insurance coverage is sufficient for all life cycle phases or that the participant or an advisor specifically excluded insurance determinations from the participant plan.

If it is determined that insurance plan(s) are recommended but not a Life Insurance Option, a set of rules can determine the amount of new insurance, the new insurance plan(s), and the duration of the new insurance plan(s). The results can then be compared to other alternatives. If it is determined that insurance, including a Life Insurance Option, is recommended, a set of rules can then determine a new, current insurance amount (could possibly be zero); a new, current insurance plan; a duration of the new, current insurance plan; amount(s) for future Life Insurance Option(s); exercise dates for future Life Insurance Option(s); and insurance plan(s) for future Life Insurance Option(s). The results may also be compared to other alternatives. It may be determined that an optimized life insurance package is recommended based on optimization among alternative options, insurance amount(s), insurance plan(s), and duration(s) of coverage, as examples.

Techniques consistent with the present disclosure provide, among other features, systems and methods for generating optimized life insurance packages and illustrating Life Insurance Options for purchase by a consumer. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A computer-implemented method for generating an optimized life insurance package, comprising:
collecting, through at least one graphical user interface, consumer data comprising an age and a risk class;
determining, with at least one processor, a match between at least one life insurance policy and at least one Life Insurance Option, wherein the match is determined based at least partially on a period of coverage for the at least one life insurance policy and at least a portion of the consumer data;
generating an optimized life insurance package comprising the at least one Life Insurance Option; and
transmitting, to the user computer, data configured to generate at least one graphical user interface comprising a visual representation of the optimized life insurance package.

2. The computer-implemented method of claim 1, wherein the match is determined by at least the following steps:
determining, with at least one processor, associations between a plurality of life insurance policies stored in at least one life insurance database and a plurality of Life Insurance Options, wherein each life insurance policy corresponds to eligibility requirements;
determining a plurality of eligible life insurance policies and the plurality of Life Insurance Options based at least partially on the consumer data and the eligibility requirements, wherein a consumer associated with the consumer data meets the eligibility requirements for the plurality of life insurance policies; and
identifying, with at least one processor, the at least one life insurance policy from the plurality of life insurance policies and the at least one Life Insurance Option from the plurality of Life Insurance Options based at least partially on the associations.

3. The computer-implemented method of claim 1, wherein the optimized life insurance package comprises the at least one life insurance policy, and wherein the at least one life insurance policy is identified: based on the consumer data, based on input from the consumer, based on input from an agent, based on input from an advisor, based on input from a representative, or any combination thereof.

4. The computer-implemented method of claim 1, wherein the at least one life insurance database comprises at least one of a local database and a remote third-party database.

5. The computer-implemented method of claim 1, wherein the visual representation comprises at least one policy illustration of the optimized life insurance package.

6. The computer-implemented method of claim 5, wherein the optimized life insurance package comprises a plurality of Life Insurance Options, and wherein the at least one policy illustration comprises a premium and option period for each of the plurality of Life Insurance Options.

7. The computer-implemented method of claim 5, wherein the at least one policy illustration comprises an interactive user interface programmed to facilitate a user to interact with the at least one policy illustration.

8. The computer-implemented method of claim 1, wherein the at least one Life Insurance Option comprises a guarantee that the consumer can exercise an option, at a later time, to do at least one of the following: purchase at least one life insurance policy at a guaranteed price, purchase at least one life insurance policy at a guaranteed risk class, or any combination thereof.

9. The computer-implemented method of claim 1, further comprising:
receiving a selection of a Life Insurance Option from the at least one Life Insurance Option, wherein the Life Insurance Option comprises an option contract that guarantees the consumer an ability to purchase a life insurance policy corresponding to the Life Insurance Option at or after a specified period of time or date.

10. The computer-implemented method of claim 1, wherein the optimized life insurance package comprises a life insurance policy having a term, and wherein the at least one Life Insurance Option is based on the term of the life insurance policy.

11. The computer-implemented method of claim 1, wherein the optimized life insurance package comprises a plurality of life insurance policies each having terms, and wherein the aggregate terms of the plurality of life insurance policies extend over a coverage period.

12. The computer-implemented method of claim 1, wherein the at least one Life Insurance Option comprises an option date, wherein the optimized life insurance package comprises at least one life insurance policy having a term, and wherein the at least one Life Insurance Option is determined based at least partially on the option date and the term of the at least one life insurance policy.

13. A computer program product for generating an optimized life insurance package, the computer program product comprising at least one non-transitory medium containing program instructions that, when executed by at least one processor of at least one computer, cause the at least one computer to:
transmit, to a user computer, data configured to generate at least one graphical user interface programmed to collect consumer data, the consumer data comprising an age and a risk class;
determine at least one Life Insurance Option available to the consumer based at least partially on the consumer data and a term of at least one life insurance policy, the at least one Life Insurance Option comprising an option date and a cost; and
generate at least one life insurance policy illustration based at least partially on the at least one Life Insurance Option.

14. The computer program product of claim 13, wherein the at least one life insurance policy is identified based at least partially on the consumer data, and wherein the at least one life insurance policy illustration is generated based at least partially on the at least one life insurance policy.

15. The computer program product of claim 13, wherein the at least one life insurance policy is owned by the consumer, and wherein the at least one graphical user interface is further programmed to collect policy information regarding the at least one life insurance policy.

16. The computer program product of claim 13, wherein determining the at least one Life Insurance Option available to the consumer comprises: determining a match between at least one life insurance policy and the at least one Life Insurance Option, and wherein the match is determined based at least partially on a period of coverage for the at least one life insurance policy and at least a portion of the consumer data.

17. The computer program product of claim 16, wherein determining the match between the at least one life insurance policy and the at least one Life Insurance Option comprises:
determining, with at least one processor, associations between a plurality of life insurance policies and a plurality of Life Insurance Options, wherein each life insurance policy corresponds to eligibility requirements;
determining a plurality of eligible life insurance policies and a plurality of Life Insurance Options based at least partially on the consumer data and the eligibility requirements, wherein a consumer associated with the consumer data meets the eligibility requirements for the plurality of life insurance policies; and
identifying, with at least one processor, the at least one life insurance policy from the plurality of life insurance policies and the at least one Life Insurance Option from the plurality of Life Insurance Options based at least partially on the associations.

18. The computer program product of claim 13, wherein the visual representation comprises at least one policy illustration of the optimized life insurance package, and wherein the at least one policy illustration comprises a premium and option period for each of the plurality of Life Insurance Options.

19. The computer program product of claim 13, wherein the at least one policy illustration comprises an interactive user interface programmed to facilitate a user to select at least one Life Insurance Option.

20. The computer program product of claim 13, wherein the program instructions, when executed by the at least one processor of the at least one computer, further cause the at least one computer to:
receive a selection of a Life Insurance Option from the at least one Life Insurance Option, wherein the Life Insurance Option comprises an option contract that allows the consumer to exercise an option, at a later time, to do at least one of the following: purchase at least one life insurance policy at a guaranteed price, purchase at least one life insurance policy at a guaranteed risk class, or any combination thereof.

21. The computer program product of claim 13, wherein the optimized life insurance package comprises a life insurance policy having a term, and wherein the at least one Life Insurance Option is based on the term of the life insurance policy.

22. The computer program product of claim 13, wherein determining the at least one Life Insurance Option available to the consumer comprises: generating an optimal life insurance package for the consumer, the optimal life insurance package including the at least one Life Insurance Option and the at least one life insurance policy, wherein the at least one Life Insurance Option corresponds to the at least one life insurance policy based at least partially on a period of coverage for the at least one life insurance policy.

23. A system for generating an optimized life insurance package, comprising at least one server computer including at least one processor, the at least one server computer programmed to:
generate at least one graphical user interface;
collect, through the at least one graphical user interface, consumer data comprising an age and a risk class;
identify at least one Life Insurance Option that matches at least one life insurance policy based at least partially on a coverage period for the at least one life insurance policy and at least a portion of the consumer data;
generate an optimized life insurance package comprising the at least one Life Insurance Option; and
generate at least one policy illustration of the optimized life insurance package.

24. The system of claim 23, wherein the at least one server is further programmed to: identify the at least one life insurance policy from at least one life insurance database, and wherein the at least one life insurance database is at least one of a local database and a remote third-party database.

25. The system of claim 23, wherein the at least one life insurance policy is input by a user.

26. The system of claim 23, wherein the at least one Life Insurance Option is determined by:
determining, with at least one processor, associations between a plurality of life insurance policies and a plurality of Life Insurance Options, wherein each life insurance policy corresponds to eligibility requirements;
determining a plurality of eligible life insurance policies and a plurality of corresponding Life Insurance Options based at least partially on the consumer data and the eligibility requirements, wherein a consumer associated with the consumer data meets the eligibility requirements for the plurality of life insurance policies; and
identifying, with at least one processor, the at least one Life Insurance Option from the plurality of Life Insurance Options based at least partially on the associations.

27. The system of claim 23, wherein the at least one policy illustration comprises a premium and option period for each of the plurality of Life Insurance Options.

28. The system of claim 23, wherein the at least one Life Insurance Option comprises a guarantee that the consumer can exercise an option, at a later time, to do at least one of the following: purchase at least one life insurance policy at a guaranteed price, purchase at least one life insurance policy at a guaranteed risk class, or any combination thereof.

29. The system of claim 23, wherein the at least one server computer is further programmed to:
receive a selection of a Life Insurance Option from the at least one Life Insurance Option, wherein the Life Insurance Option comprises an option contract that guarantees the consumer an ability to purchase a life insurance policy corresponding to the Life Insurance Option at or after a specified period of time or date.

30. The method of claim 1, wherein the period of coverage for the at least one life insurance policy is flexible.

31. The method of claim 1, wherein the consumer data further comprises at least one of the following: coverage objectives, financial objectives, risk tolerance, desired coverage, anticipated timing, or any combination thereof.

32. The method of claim 1, wherein determining the match between the at least one life insurance policy and the at least one Life Insurance Option comprises identifying a pre-defined package comprising the at least one life insurance policy and the at least one Life Insurance Option.
